(19) United States
(12) Patent Application Publication
(10) Pub. No.: US 2009/0136036 A1
(43) Pub. Date: May 28, 2009

(54) COMMUNICATION METHOD FOR EXECUTING HANDOVER, AND BASE STATION APPARATUS, TERMINAL APPARATUS AND CONTROL APPARATUS USING THE COMMUNICATION METHOD

(76) Inventor: Makoto OKADA, Mizuho-City (JP)

Correspondence Address: MCDERMOTT WILL & EMERY LLP, 600 13TH STREET, N.W., WASHINGTON, DC, 20005-3096, US

(21) Appl. No.: 12/275,790

(22) Filed: Nov. 21, 2008

(30) Foreign Application Priority Data
Nov. 22, 2007 (JP) 2007-303124

(51) Int. Cl. H04L 9/00

(52) U.S. Cl. 380/272; 380/277

(57) ABSTRACT

A receiving unit receives a handover request from a terminal apparatus. As the handover request is received, a requesting unit requests a control apparatus connected via a network that an encryption key used for wireless communication performed between the terminal apparatus and a handover source base station apparatus be outputted. As the encryption key is received from the control apparatus as a response to the request, a tentative execution unit performs wireless communication with the terminal using the encryption key using the encryption key. While wireless communication is being performed between the tentative execution unit and the terminal, a setting unit determines a new encryption key between the setting unit and the terminal and continues to perform wireless communication after updating the encryption key with the new encryption key.

### CROSS-REFERENCE TO RELATED APPLICATIONS

This application is based upon and claims the benefit of priority from the prior Japanese Patent Application No. 2007-303124, filed on Nov. 22, 2007, the entire contents of which are incorporated herein by reference.

### BACKGROUND OF THE INVENTION

1. Field of the Invention

The present invention relates to a communication technique, in particular, to a communication method for executing handover, and a base station apparatus, a terminal apparatus and a control apparatus utilizing the communication method.

2. Description of the Related Art

When communications are performed among a plurality of communication apparatuses, encryption is practiced to prevent the leakage of data. In one of various encryption techniques proposed so far, a common encryption key is used in a receiving end and a transmitting end. In a wireless communication system comprised of a base station apparatus and a terminal apparatus, a common encryption key is used between the base station apparatus and the terminal apparatus. For instance, in a related art, when communication is likely to be performed between a terminal apparatus and a base station apparatus, the identification information on this terminal apparatus is distributed to the base station apparatus and an encryption key is generated according to the terminal apparatus trying to access the base station apparatus. In another related art, a foreign agent being connected to the terminal apparatus conveys beforehand authentication information to a plurality of neighboring foreign agents.

When a terminal apparatus is performing encrypted wireless communication with a base station apparatus (hereinafter referred to as “handover source base station apparatus”), there are cases where the terminal apparatus performs handover to another base station apparatus (hereinafter referred to as “handover destination base station apparatus”). When an encryption key is generated while the terminal apparatus performs handover to a handover destination apparatus, time required for the handover becomes longer due to the generation of the encryption key. This may lead to cut-off of the ongoing communication, thus being most inconvenient for a user. If encryption is not carried out for a short while after the handover has been done to the handover destination base station apparatus or a common encryption key is used by a plurality of base station apparatuses, the time for handover will be reduced but the security will be at risk.

### SUMMARY OF THE INVENTION

The present invention has been made under the foregoing circumstances, and a general purpose thereof is to provide a communication technique that reduces the period of time required for the handover while maintaining the security.

In order to resolve the above problems, a base station apparatus according to one embodiment of the present invention comprises: a receiving unit which receives a handover request from a terminal apparatus; a requesting unit which, upon receipt of the handover request in the receiving unit, requests a control apparatus connected via a network that an encryption key used for wireless communication performed between the terminal apparatus and a handover source base station apparatus be outputted; a communication unit which, upon receipt of the encryption key from the control apparatus as a response to a request from said requesting unit, performs wireless communication with the terminal apparatus using the encryption key. While performing wireless communication with the terminal apparatus using the encryption key, the communication unit determines a new encryption key between the communication unit and the terminal apparatus, and continues to perform wireless communication after updating the encryption key with the new encryption key.

Another embodiment of the present invention relates to a terminal apparatus. This apparatus comprises: a first communication unit which performs wireless communication with a handover source base station apparatus using an encryption key; and a second communication unit which performs wireless communication with a handover destination base station apparatus tentatively using the encryption key used by the first communication unit. While performing wireless communication with the handover destination apparatus tentatively using the encryption key used by the first communication unit, the second communication unit determines a new encryption key between the second communication unit and the handover destination base station apparatus and continues to perform wireless communication after updating the encryption key with the new encryption key.

Still another embodiment of the present invention relates to a control apparatus. This control apparatus is connected to a handover source base station apparatus performing wireless communication with a terminal apparatus via a network, and it comprises: a management unit which manages an encryption key used for wireless communication between the handover source base station apparatus and the terminal apparatus; and an instruction unit which, upon receipt of an output request of outputting the encryption key managed by the management unit from a handover destination base station apparatus connected to the network, outputs the encryption key managed by the management unit to the handover destination base station apparatus in order that the encryption key is tentatively used for wireless communication between the handover destination base station apparatus and the terminal apparatus. When a new encryption key is determined between the handover destination base station apparatus and the terminal apparatus after the encryption key has been outputted from the instruction unit in a state where the encryption key is being tentatively used between the handover destination base station apparatus and the terminal apparatus, the management unit manages the new encryption key.

Still another embodiment according to the present invention relates to a communication method. This method comprises: performing wireless communication between a terminal apparatus and a handover source base station apparatus using an encryption key; performing wireless communication between the terminal apparatus and a handover destination base station apparatus by tentatively using the encryption key; determining a new encryption key by the terminal apparatus and the handover destination apparatus in a state where the encryption is being used tentatively; and continuing to perform wireless communication between the terminal apparatus and the handover destination base station apparatus after the encryption key has been updated with the new encryption key.

Still another embodiment according to the present invention relates also to a communication method. This method comprises: managing an encryption key used for wireless communication between a handover source base station apparatus and a terminal apparatus; and upon receipt of an output request of outputting the encryption key managed by the managing from a handover destination base station apparatus connected to a network, outputting the encryption key managed by the managing to the handover destination base station apparatus in order that the encryption key is tentatively used for wireless communication between the handover destination base station apparatus and the terminal apparatus; and managing a new encryption key after the outputting the encryption key in a state where the encryption key is being used tentatively for wireless communication performed between the handover destination base station apparatus and the terminal, when the new encryption key is determined between the handover destination apparatus and the terminal.

Optional combinations of the aforementioned constituting elements, and implementations of the invention in the form of methods, apparatuses, systems, recording mediums, computer programs and so forth may also be practiced as additional modes of the present invention.

### BRIEF DESCRIPTION OF THE DRAWINGS

Embodiments will now be described by way of examples only, with reference to the accompanying drawings which are meant to be exemplary, not limiting, and wherein like elements are numbered alike in several Figures in which:

FIG. 1 shows a structure of a communication system according to an exemplary embodiment of the present invention;

FIG. 2A shows a structure of a frame in a communication system of FIG. 1;

FIG. 2B shows a structure of a frame in the communication system of FIG. 1;

FIG. 2C shows a structure of a frame in the communication system of FIG. 1;

FIG. 3 shows an assignment of sub-channels in the communication system of FIG. 1;

FIG. 4 shows a structure of a base station apparatus of FIG. 1;

FIG. 5 shows a structure of a terminal apparatus of FIG. 1;

FIG. 6 shows a structure of PAC of FIG. 1; and

FIG. 7 is a sequence diagram showing a handover procedure in the communication system of FIG. 1.

### DETAILED DESCRIPTION OF THE INVENTION

The invention will now be described by reference to the preferred embodiments. This does not intend to limit the scope of the present invention, but to exemplify the invention.

The present invention will be outlined hereinbelow before it is described in detail. Exemplary embodiments of the present invention relates to a communication system comprised of a plurality of base station apparatuses, a terminal apparatus, and PAC (Paging Area Controller). One of a plurality of base station apparatuses corresponds to a handover source base station apparatus, whereas another one of the plurality of base station apparatuses corresponds to a handover destination base station apparatus. The terminal apparatus is connected to the handover source base station apparatus via a wireless network, and carries out wireless communications with the handover source base station apparatus. In so doing, encryption is carried out using an encryption key in the communications between the terminal apparatus and the handover source base station apparatus. Hereinafter, encrypted wireless communications will be referred to as “encrypted communication”. A known technique may be used as an encryption technique. For the clarity of description, it is assumed herein that a common key cryptosystem is used.

The terminal apparatus changes the position from a neighborhood of the handover source base station to a neighborhood of the handover destination apparatus, so that the terminal apparatus performs handover from the handover source base station apparatus to the handover destination base station apparatus. Since the terminal apparatus also performs encrypted communication with the handover source base station apparatus, the terminal apparatus sets an encryption key between the terminal apparatus and the handover source base station apparatus. On the other hand, when the period required for the setting of the encryption key gets long, the wireless communication is discontinued. In order to cope with this problem, the communication system according to the present exemplary embodiment is configured as follows.

The PAC is connected to the handover source base station apparatus and the handover destination base station apparatus via a wired network. While the terminal apparatus and the handover source base station apparatus are performing encrypted communication with each other, the PAC manages the encryption key used for this encrypted communication (hereinafter referred to as “old encryption key”). When handover is carried out from the handover source base station apparatus to the handover destination base station apparatus, the handover destination base station apparatus acquires the old encryption key from the PAC. While using the encryption key which has been in use so far, the handover destination base station apparatus and the terminal apparatus perform encrypted communication with each other. While performing such encrypted communication with each other, the handover destination base station apparatus and the terminal apparatus set a new encryption key (hereinafter referred to as “new encryption key”). After this, the handover destination base station apparatus and the terminal updates the old encryption key with the new encryption key and continues the encrypted communication.

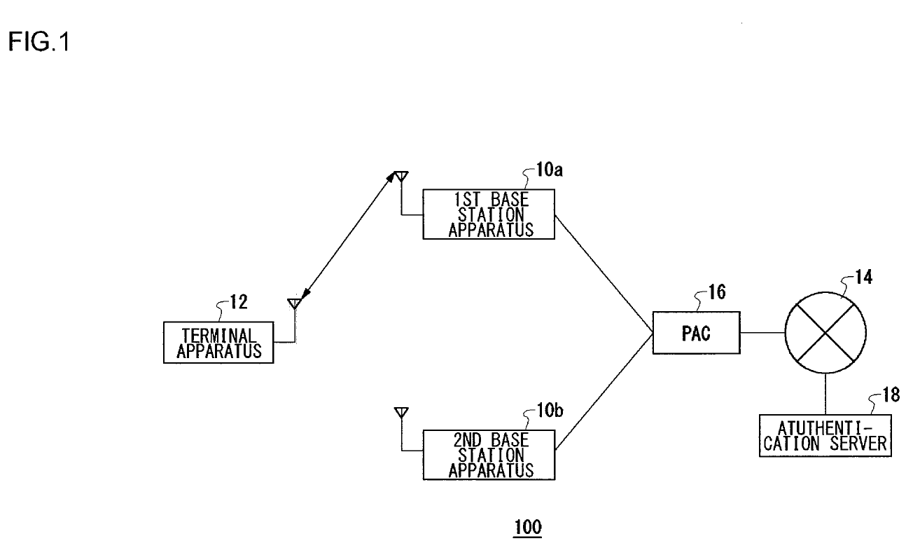

FIG. 1 shows a structure of a communication system 100 according to an exemplary embodiment of the present invention. The communication system 100 includes a first base station apparatus 10a and a second base station apparatus 10b, which are generically referred to as “base station apparatus 10”, a terminal apparatus 12, a network 14, a PAC 16, and an authentication server 18. Here, the first base station apparatus 10a corresponds to the above-described handover source base station apparatus, whereas the second base station apparatus 10b corresponds to the above-described handover destination base station apparatus.

One end of the base station apparatus 10 connects to the terminal apparatus 12 via the wireless network, whereas the other end thereof connects to a wired network 14 via the PAC 16. The base station apparatus 10 performs wireless communication with the terminal apparatus 12 by allocating a communication channel thereto. More specifically, the base station apparatus 10 broadcasts beacon, and the terminal apparatus 12 recognizes the presence of the base station apparatus 10 by receiving the beacon. Then the terminal apparatus 12 transmits to the base station apparatus 10 a request signal requesting a channel allocation. In response to a received request signal, the base station apparatus 10 allocates a communication channel to the terminal apparatus 12.

Also, the base station apparatus 10 transmits information on the communication channel allocated to the terminal apparatus 12, and the terminal apparatus 12 executes communication with the base station apparatus using the allocated communication channel. As a result, the data transmitted from the terminal apparatus 12 are outputted to the network 14 via the base station apparatus 10 and are finally received by a not-shown communication apparatus via the network 14. The data are also transmitted toward the terminal apparatus 12 from the communication apparatus. At the time of data communication, encrypted communication is being executed. Though the first base station apparatus 10a is connected to the terminal apparatus 12 in an initial state, the second base station apparatus 10b is connected to the terminal apparatus 12 by handover.

Here, the communication system 100 uses an OFDMA (Orthogonal Frequency Division Multiple Access) scheme. OFDMA is a technique in which a plurality of terminal apparatuses are frequency-multiplexed using OFDM. In such an OFDMA scheme, sub-channels are formed by multiple subcarriers, and a plurality of sub-channels are frequency-division multiplexed. When combined with TDMA, a subcarrier signal is divided into a plurality of time slots on the time axis. In other words, each frame is formed when a plurality of time slots are time-division multiplexed. And each time slot is formed when a plurality of sub-channels are frequency-division multiplexed. And each sub-channel is formed by a multicarrier signal. In the aforementioned explanation, a communication channel is identified by the combination of the sub-channel and the time slot. As a result, the base station apparatus 10 executes communication with the terminal apparatus 12 in a manner such that the base station apparatus 10 allocates a sub-channel in at least one time slot to the terminal apparatus 12.

One end of the PAC 16 is connected to the base station apparatus 10, whereas the other end thereof is connected to the network 14. Here, a paging area is created by a plurality of base station apparatuses 10 connected to the PAC 16, and the PAC 16 controls this paging area. In other words, when the PAC 16 receives signals, coming from a not-shown communication apparatus, which are sent to the terminal apparatus 12, the PAC 16 generates a call signal. Also, the PAC 16 transmits the call signal to a plurality of base station apparatuses 10, respectively. Assumed in such a processing is that when the terminal apparatus 12 and the base station apparatus 10 are connected to each other, the PAC 16 registers the position of the terminal apparatus 12. Note that a known technique may be used to register the position and therefore the description thereof is omitted here.

Though the detail will be discussed later, the aforementioned old encryption key is used when an encrypted communication is being performed between the terminal apparatus 12 and the first base station apparatus 10a. The PAC 16 manages the old encryption key. When the terminal apparatus 12 performs handover from the first base station apparatus 10a to the second base station apparatus 10b, the second base station apparatus 10b requests the PAC 16 to output the old encryption key. In response to the request, the PAC 16 outputs the old encryption key to the second base station 10b. The second base station apparatus 10b and the terminal apparatus 12 perform the encrypted communication with each other using the old encryption key. Such encrypted communication as this is called “tentative communication”. During the tentative communication, the PAC 16 outputs a new encryption key to the second base station apparatus 10b. Then the old encryption key is updated with the new encryption key; and thereafter the second base station apparatus 10b and the terminal apparatus 12 continue the encrypted communication. The PAC 16 manages the new encryption key.

The terminal apparatus 12 is accessible to the base station apparatus 10. As described above, the terminal apparatus 12 is connected to the first base station apparatus 10a in an initial state, and then the handover is performed from the first base station apparatus 10a to the second base station apparatus 10b. When performing encrypted communication with the first base station apparatus 10a and performing tentative communication with the second base station apparatus 10b, the terminal apparatus 12 uses the old encryption key. As the old encryption key is updated with the new encryption key, the terminal apparatus 12 uses the new encryption key when performing encrypted communication with the second base station apparatus 10b. The authentication server 18 connects to the PAC 16 via the network 14. The authentication server 18 carries out authentication processing for the connections to the terminal apparatus 12. Any known technique may be used for the authentication processing and therefore the description thereof is omitted here.

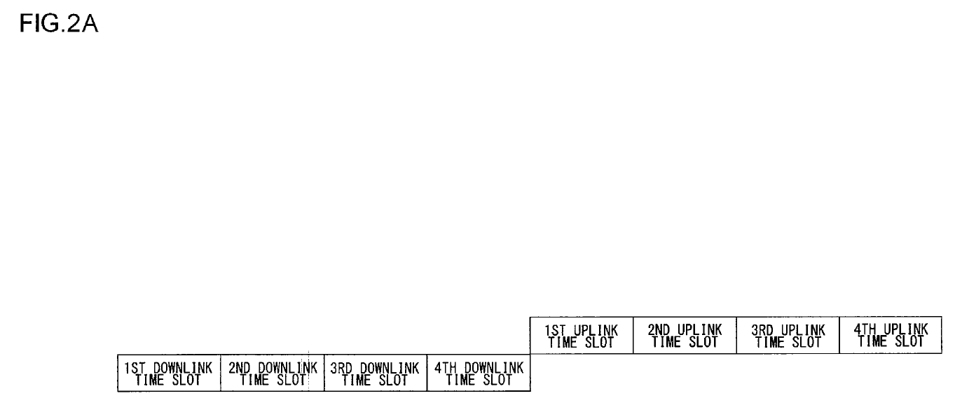

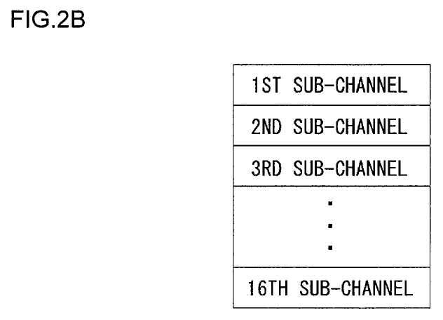

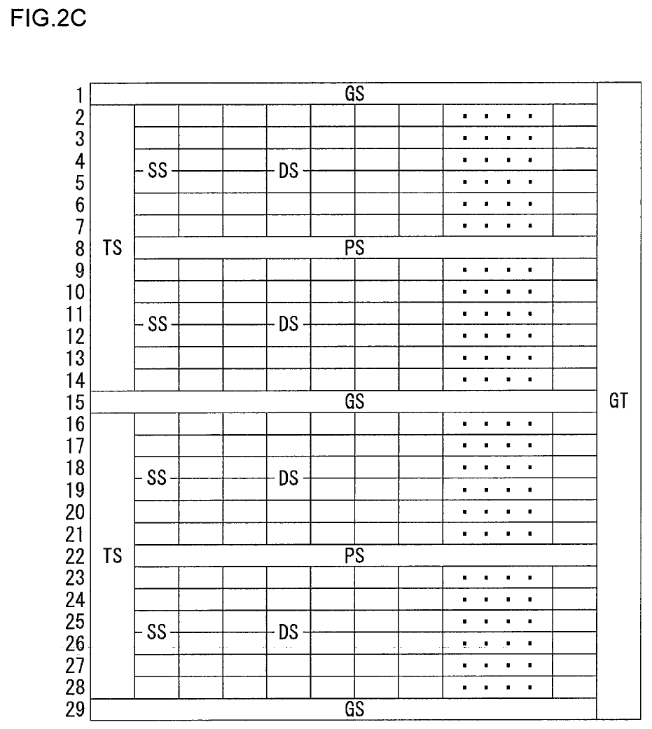

FIGS. 2A to 2C each shows a structure of a frame in the communication system 100. The horizontal direction in each of FIGS. 2A to 2C corresponds to time. A frame is constituted by eight time slots which are time-multiplexed. The eight time slots are composed of four downlink time slots and four uplink time slots. Here, the four uplink time slots are denoted as “first uplink time slot” through “fourth uplink time slot”, whereas the four downlink time slots are denoted as “first downlink time slot” through “fourth downlink time slot”. The frame as shown in each of FIGS. 2A to 2C is repeated contiguously.

Note that the structure of a frame is not limited to that of FIG. 2A and, for example, a frame may be constituted by four time slots or sixteen time slots. For the clarity of explanation, a description will be given hereinbelow of the structure of a frame assuming that the frame is constituted as shown in FIG. 2A. For the simplicity of explanation, the structure of an uplink time slot and that of a downlink time slot are identical to each other. Accordingly, if a description is given of the uplink time slots only or the downlink time slots only, the same description will be valid for the other time slots. A plurality of contiguous frames form a super frame wherein each of the frames is one as shown in FIG. 2A. Assume herein, for example, that a super frame is constituted by “twenty” frames.

FIG. 2B shows a structure of one of the time slots shown in FIG. 2A. The vertical direction of FIG. 2B corresponds to the frequency axis. As shown in FIG. 2B, one time slot is formed by frequency-multiplexing “16” sub-channels of “first sub-channel” through “sixteenth sub-channel”. Such a plurality of sub-channels as these are frequency-division multiplexed. Since each time slot is constituted as shown in FIG. 2B, the aforementioned communication channel is identified by the combination of a time slot and a sub-channel. Also, a frame construction corresponding to one of the sub-channels shown in FIG. 2B may be one shown in FIG. 2A. Note that the number of sub-channels assigned to a time slot may not be “16”. Assume here that the allocation of sub-channels in the uplink time slots and the allocation of sub-channels in the downlink time slots are identical to each other. Assume also that at least one broadcast signal (beacon) is assigned to each super frame. For example, beacon is assigned to a sub-channel in a time slot among a plurality of downlink time slots contained in a super frame.

FIG. 2C shows a structure of one of the sub-channels shown in FIG. 2B. FIG. 2C corresponds to the aforementioned packet signal. Similar to FIGS. 2A and 2B, the horizontal direction thereof corresponds to the time axis, whereas the vertical direction thereof corresponds to the frequency axis. The numbers “1” to “29” are given along the frequency axis. These numbers indicate subcarrier numbers. In this manner, a sub-channel is constituted by multicarrier signals, in particular, OFDM signals. “TS” in FIG. 2C denotes a training signal, which is constituted by a known value. “SS” denotes a signal symbol. “GS” denotes a guard symbol and no substantial signal is assigned here. “PS” denotes a pilot symbol, which is constituted by a known value. “DS” denotes a data symbol, which is data to be transmitted. “GT” denotes a guard time and no substantial signal is assigned here.

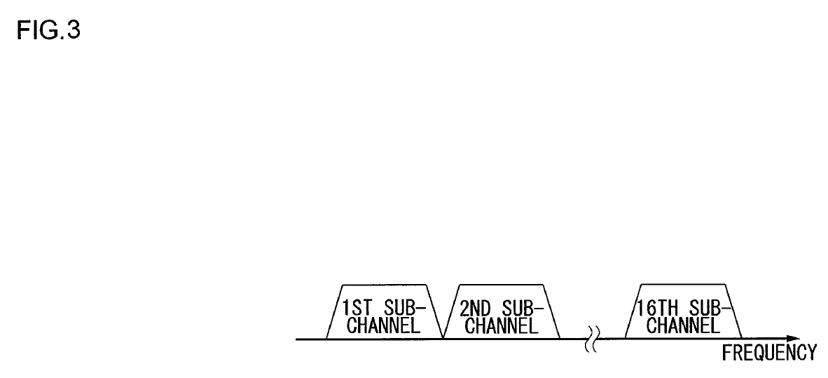

FIG. 3 shows an assignment of sub-channels in the communication system 100. In FIG. 3, the horizontal axis represents the frequency axis and illustrates the spectrum for time slots shown in FIG. 2B. As described above, sixteen sub-channels composed of the first sub-channel to the sixteenth sub-channel are frequency-division multiplexed in each time slot. Each sub-channel is constituted by multicarrier signals, namely, OFDM signals here.

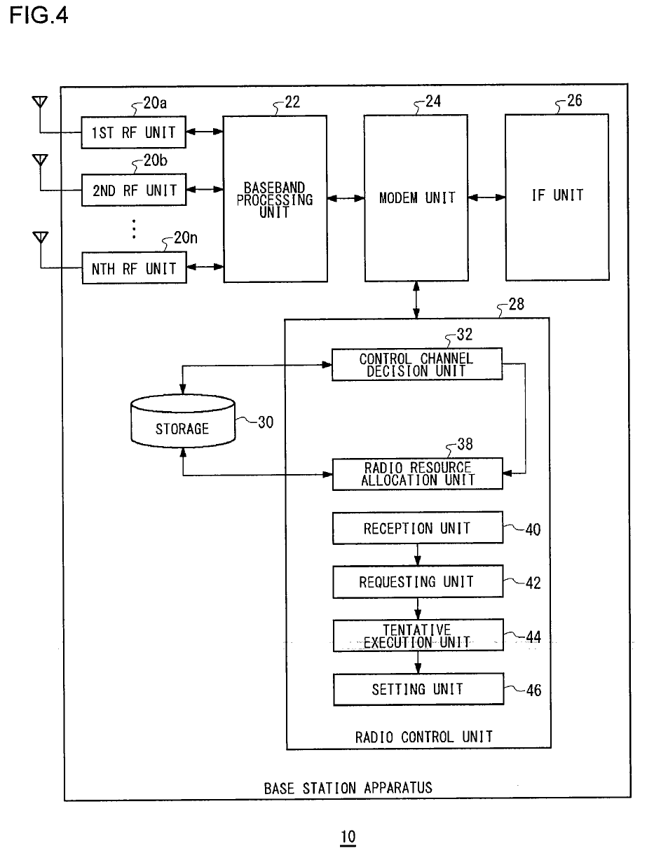

FIG. 4 shows a structure of the base station apparatus 10. The base station apparatus 10 includes a first RF unit 20a, a second RF unit 20b, . . . and an Nth RF unit 20n, which are generically referred to as “RF unit 20”, a baseband processing unit 22, a modem unit 24, an IF unit 26, a radio control unit 28, and a storage 30. The radio control unit 28 includes a control channel decision unit 32, a radio resource allocation unit 38, a reception unit 40, a requesting unit 42, a tentative execution unit 44, and a setting unit 46.

The RF unit 20 performs frequency conversion on radiofrequency multicarrier signals received from a not-shown terminal apparatus 12 so as to produce baseband multicarrier signals. Here, the multicarrier signal is formed as shown in FIG. 3 and corresponds to an uplink time slot as shown in FIG. 2A. Further, the RF unit 20 outputs the baseband multicarrier signal to the baseband processing unit 22. The baseband multicarrier signal, which is composed of in-phase components and quadrature components, shall generally be transmitted by two signal lines. For the clarity of Figures, the baseband multicarrier signal is presented here by a single signal line only. An AGC (Automatic Gain Control) unit and an A-D conversion unit are also included in the RF unit 20.

As a transmission processing, the RF unit 20 performs frequency conversion on the baseband multicarrier signals inputted from the baseband processing unit 22 and thereby produces radiofrequency multicarrier signals. Further, the RF unit 20 transmits the radiofrequency multicarrier signals. The RF unit 20 transmits the multicarrier signals using the same radio-frequency band as that of the received multicarrier signals. That is, assume that TDD (Time Division Duplex) is in use as shown in FIG. 2A. A PA (Power Amplifier) and a D-A conversion unit are also included in the RF unit 20.

As a receiving processing, the baseband processing unit 22 receives the input of baseband multicarrier signals from a plurality of RF units 20, respectively. Since the baseband multicarrier signal is a time-domain signal, the baseband processing unit 22 converts a time-domain signal into a frequency-domain signal through FFT so as to perform adaptive array signal processing on the thus converted frequency-domain signals. Also, the baseband processing unit 22 sets timing synchronization, namely FFT windows, and removes the guard intervals. A known technique may be used for the timing synchronization or the like and therefore the description thereof is omitted here. The baseband processing unit 22 outputs the results of the adaptive array signal processing to the modem unit 24. As a transmission processing, the baseband processing unit 22 receives the input of the frequency-domain multicarrier signals and perform spreading processing on them by a weight vector.

As a transmission processing, the baseband processing unit 22 converts the frequency-domain signals, which are the frequency-domain multicarrier signals inputted from the modem unit 24, into the time domain through IFFT, and outputs the thus converted time-domain signal to the RF unit 20. The baseband processing unit 22 also appends guard intervals but the description thereof is omitted here. Here, as shown in FIG. 2B, the frequency-domain signal contains a plurality of sub-channels, and each of the sub-channels contains a plurality of subcarriers as in the vertical direction shown in FIG. 2C. For the clarity of figure, the frequency-domain signal is arranged in the order of the subcarrier numbers, and forms serial signals.

As a receiving processing, the modem unit 24 demodulates the frequency-domain multicarrier signals outputted from the baseband processing unit 22. The multicarrier signals converted into the frequency domain have components corresponding respectively to a plurality of subcarriers as shown in FIG. 2B and FIG. 2C. Demodulation is done on a subcarrier-by-subcarrier basis. The modem unit 24 outputs the demodulated signals to the IF unit 26. As a transmission processing, the modem unit 24 carries out modulation. The modem unit 24 outputs the modulated signals to the baseband processing unit 22 as frequency-domain signals.

As a receiving processing, the IF unit 26 receives a demodulation result from the modem unit 24 and separates the demodulation result in units of terminal apparatus 12. That is, the demodulation result is composed of a plurality of sub-channels. Accordingly, if each sub-channel is allocated to each terminal apparatus 12, the demodulation result will contain signals from a plurality of terminal apparatuses. The IF unit 26 separates such a demodulation result for each terminal apparatus 12. The IF unit 26 outputs the thus separated demodulation results to the not-shown network 14. In so doing, the IF unit 26 executes transmission according to information, with which to identify the destination, such as IP (Internet Protocol) address.

As a transmission processing, the IF unit 26 inputs data for a plurality of terminal apparatuses 12, from the not-shown network 14. The IF unit 26 allocates data to sub-channels and forms multicarrier signals from a plurality of sub-channels. That is, as shown in FIG. 3, the IF unit 26 forms the multicarrier signal composed of a plurality of sub-channels. Assume herein that the sub-channels allocated to the data are determined beforehand as in FIG. 2C and the instructions as to the allocation are received from the radio control unit 28. The IF unit 25 outputs the multicarrier signals to the modem unit 24.

The radio control unit 28 controls the operation of the base station apparatus 10. As shown in FIGS. 2A to 2C and FIG. 3, the radio control unit 28 defines time slots formed by the frequency multiplexing of a plurality of sub-channels and defines frames formed by the time multiplexing of a plurality of time slots. The radio control unit 28 instructs the modem unit 24 and the like to form the packet signals, broadcasts beacon from the modem unit 24 via the RF unit 20, and so forth. The control channel decision unit 32 allocates beacon to sub-channels. Here, beacon is a signal that contains information used to control communication with the terminal apparatus 12. It may be concluded here that the beacon or the like signal is more important than the packet signal containing the data. The control channel decision unit 32 selects a predetermined sub-channel by referencing the storage 30. The control channel decision unit 32 conveys the selected sub-channel to the radio resource allocation unit 38.

The radio resource allocation unit 38 allocates the sub-channel to the beacon according to the notification from the control channel decision unit 32. In cooperation with the radio control unit 28, the storage 30 stores information on the sub-channel allocated to the terminal apparatus 12 and information on a control channel. After beacon has been transmitted, the radio resource allocation unit 38 receives a sub-channel allocation request sent from the not-shown terminal apparatus 12, from the RF unit 20 via the modem unit 24. Though a ranging processing is performed between the base station apparatus 10 and the terminal apparatus 12 before the sub-channel allocation request is received, the description thereof is omitted here. The sub-channel allocation request is also called a radio resource acquisition request. The radio resource allocation unit 38 allocates the sub-channel to the terminal apparatus 12 that has received the allocation request.

Here, the radio resource allocation unit 38 allocates sub-channels contained in the uplink time slots and the downlink time slots, to the terminal apparatus 12. In particular, assume that the allocation of sub-channels in the uplink time slots and the allocation of sub-channels in the downlink time slots are symmetrical to each other. When allocating the sub-channels, the radio resource allocation unit 38 references the information on the type of MAC protocols, the type of upper-layer protocols contained in the radio resource acquisition request and the like; however, the description thereof is omitted here. The radio resource allocation unit 38 transmits an allocation notification to this terminal apparatus 12 from the modem unit 24 via the RF unit 20. The allocation notification is also called a radio resource allocation. The allocation notification contains the allocated sub-channel and time slots. After the above-described processing has been carried out, the radio control unit 28 causes the RF unit 20 and the modem unit 24 to perform communication with the terminal apparatus 12 to which the sub-channel has been allocated.

The radio control unit 28 performs encrypted communication with the terminal apparatus 12. In other words, the radio control unit 28 sets an encryption key to be used for the encrypted communication, and performs encryption and decoding using the encryption key set. If the base station apparatus 10 corresponds to the first base station apparatus 10a, the radio control unit 28 will set the old encryption key; and if the base station apparatus 10 corresponds to the second base station apparatus 10b, the control unit 28 will set a new encryption key while using the old encryption key. A description is first given of a case where the base station apparatus 10 corresponds to the first base station apparatus 10a. After having received a connection request, namely a sub-channel allocation request, from the terminal apparatus 12 via the RF unit 20, the baseband processing unit 22 and the modem unit 24, the radio control unit 28 receives an authentication start request. The radio control unit 28 transmits the authentication start request to the PAC 16 from the IF unit 26. Then as the encryption key is received from the PAC 16 via the IF unit 26, the radio control unit 28 stores the encryption key. This encryption key corresponds to the aforementioned old encryption key. After challenge/response authentication has been performed between the radio control unit 28 and the terminal apparatus 12 via the RF unit 20, the baseband processing unit 22 and the modem unit 24, the radio control unit 28 transmits the old encryption key to the terminal apparatus 12 in response to the request sent from the terminal apparatus 12. As a result, encrypted communication is performed.

A description is next given of a case where the base station apparatus 10 corresponds to the second base station apparatus 10b. The reception unit 40 receives a connection request sent from the terminal apparatus 12, namely a sub-channel allocation request sent therefrom, via the RF unit 20, the baseband processing unit 22 and the modem unit 24. This may be also called a handover request. Upon reception of the request by the reception unit 40, the requesting unit 42 makes a request to the PAC 16 connected via the network 14 that the old encryption key be outputted from the IF unit 26. Accordingly, the identification information used to identify the first base station apparatus 10a which is a handover source is contained in the handover request, and the requesting unit 42 also has this information contained in the request.

As a response to the request made by the requesting unit 42, the tentative execution unit 44 receives the old encryption key sent from the PAC 16, via the RF unit 20, the baseband processing unit 22 and the modem unit 24. While using the old encryption key, the tentative execution unit 44 causes the terminal apparatus 12 to perform tentative communication with the modem unit 24, the baseband processing unit 22 and the RF unit 20. That is, since the terminal apparatus 12 has been performing encrypted communication with the first base station apparatus 10a so far, the terminal apparatus 12 recognizes the old encryption key and the tentative execution unit 44 also recognizes the old encryption key. As a result, the tentative execution unit 44 and the terminal apparatus 12 immediately perform tentative communication with each other without the trouble of verifying the old encryption key with each other.

While performing tentative communication with the terminal apparatus 12 using the old encryption key, the setting unit 46 determines the new encryption key between the setting unit 46 and the terminal apparatus 12. For example, the setting unit 46 sets another communication channel which differs from that being used for the tentative communication. The setting unit 46 allocates the another communication channel thus set to the terminal apparatus 12, and receives the authentication start request from the terminal apparatus 12, via the RF unit 20, the baseband processing unit 22 and the modem unit 24. The setting unit transmits the authentication start request to the PAC 16 from the IF unit 26.

Thereafter, as the setting unit 46 receives the encryption key from the PAC 16 via the IF unit 26, the setting unit 46 stores the encryption key. This encryption key corresponds to the aforementioned new encryption key. After challenge/response authentication has been performed between the setting unit 46 and the terminal apparatus 12 via the RF unit 20, the baseband processing unit 22 and the modem unit 24, the setting unit 46 transmits the new encryption key to the terminal apparatus 12 in response to the request sent from the terminal apparatus 12. The setting unit 46 causes the tentative execution unit 44 to disconnect the tentative communication and switch it to the encrypted communication using the new encryption key. That is, the setting unit 46 updates the old encryption key with the new encryption key.

This structure may be implemented hardwarewise by elements such as a CPU, memory and other LSIs of an arbitrary computer, and softwarewise by memory-loaded programs having communication functions or the like. Depicted herein are functional blocks implemented by cooperation of hardware and software. Therefore, it will be obvious to those skilled in the art that the functional blocks may be implemented by a variety of manners including hardware only, software only or a combination of both.

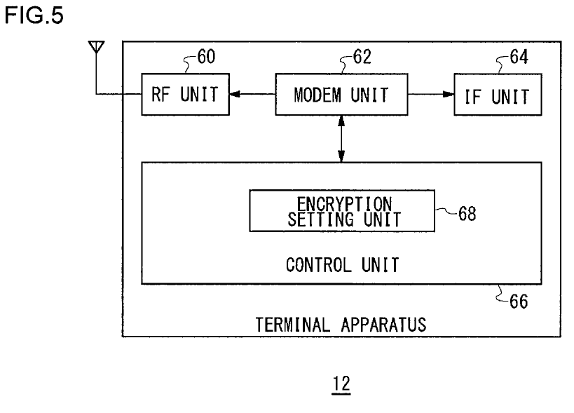

FIG. 5 shows a structure of a terminal apparatus 12. The terminal apparatus 12 includes an RF unit 60, a modem unit 62, an IF unit 64, and a control unit 66. The control unit 66 includes an encryption setting unit 68. The RF unit 60 carries out the processing corresponding to the RF unit 20 of FIG. 4, and the modem unit 62 carries out the processing corresponding to the modem unit 24 of FIG. 4 added with an FFT and an IFFT. Thus, the description of the RF unit 60 and the modem unit 62 is omitted here. The IF unit 64 has a user interface function. For example, if the IF unit 64 contains buttons and the like, it can receive instructions from a user. The IF unit 64 outputs the thus received instructions to the modem unit 62 and the control unit 66 as signals. If the IF unit 64 contains a display, the data demodulated by the modem unit 62 can be displayed.

The control unit 66 controls the entire operation of the terminal apparatus 12. The control unit 66 receives beacons sent from various base station apparatuses through the aforementioned control channel, via the RF unit 60 and the modem unit 62. Of the beacons acquired, the control unit 66 selects a base station apparatus 10 exhibiting the maximum receiving strength as a communication party. Assume here that the first base station apparatus 10a is selected. The control unit 66 transmits a sub-channel allocation request to the first base station apparatus 10a via the modem unit 62 and the RF unit 60.

Then the control unit 66 receives a sub-channel allocation notification sent from the first base station apparatus 10a, via the RF unit 60 and the modem unit 62. The encryption setting unit 68 transmits an authentication start request to the first base station apparatus 10a, using the allocated sub-channel, namely the communication channel. After challenge/response authentication has been performed between the encryption setting unit 68 and the first base station apparatus 10a, the encryption setting unit 68 transmits an encryption key request to the first base station apparatus 10a. The encryption setting unit 68 receives the encryption key, namely the old encryption key, sent from the first base station apparatus l0a. The control unit 66 has the RF unit 60 and the modem unit 62 perform encrypted communication between them and the first base station apparatus 10a using the old encryption key.

While using a known technique, the control unit 66 determines a handover to the second base station apparatus lob. The control unit 66 transmits a sub-channel allocation request signal to the second base station apparatus 10b via the modem unit 62 and the RF unit 60, and receives the sub-channel allocation notification sent from the second base station apparatus 10b, via the RF unit 60 and the modem unit 62. While using the old encryption key, the encryption setting unit 68 has the RF unit 60 and the modem unit 62 perform tentative communication with the second base station apparatus lob. Also, another communication channel different from that used for the tentative communication is set by the second base station apparatus 10b, and the encryption setting unit 68 transmits the authentication start request to the second station apparatus 10b through the another communication channel.

After challenge/response authentication has been performed between the encryption. setting unit 68 and the second base station apparatus 10b, the encryption setting unit 68 transmits an encryption key request to the second base station apparatus 10b. The encryption setting unit 68 receives the encryption key, namely the new encryption key, sent from the second base station apparatus 10b. Accordingly, the encryption setting unit 68 determines the new encryption key during the tentative communication with the second base station apparatus 10b. Then the control unit 66 has the old encryption key updated with the new encryption key. Then the control unit 66 has the RF unit 60 and the modem unit 62 continue to perform encrypted communication between them and the second base station apparatus 10b using the new encryption key. Though the control unit 66 controls the sub-channel allocation request and the data communication, these may be executed the same way as explained in the aforementioned base station apparatus 10 and therefore the repeated description thereof is omitted here.

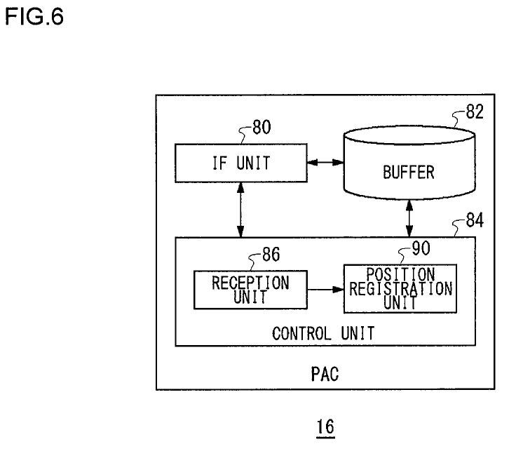

FIG. 6 shows a structure of PAC of FIG. 1. The PAC 16 includes an IF unit 80, a buffer 82, and a control unit 84. The control unit 84 includes a reception unit 86 and a position registration unit 90. The PAC 16 principally involves in registering positions and controlling handover. A description is first given of the position registration.

The IF unit 80 is connected to the not-shown base station apparatus 10 via the not-shown network 14. The reception unit 86 receives a position registration request sent from the not-shown terminal 12, via the IF unit 80. The reception unit 86 outputs the received position registration request to the position registration unit 90. The position registration unit 90 performs position registration processing on the terminal apparatus 12, using a known technique. The position registration unit 90 stores the results of position registration to the buffer 82. The IF unit 80 transmits a position registration response to the position registration request, to the terminal apparatus 12. Note that the function of position registration may not included in the PAC 16 and may be included in a not-shown switching system or the like, instead.

A description is now given of the handover control. The control unit 84 receives the authentication start request from the first base station apparatus 10a via the IF unit 80. After the control unit 84 has executed authentication processing between the control unit 84 and the authentication server 18 via the IF unit 80, the control unit 84 sets an old encryption key. Here, the old authentication key may be generated by the authentication server 18 or the control unit 84. The control unit 84 reports the old encryption key to the first base station apparatus 10a via the IF unit 80 and at the same time manages the old encryption key through the buffer 82.

After the terminal apparatus has performed handover to the second base station apparatus 10b, the control unit 84 receives from the second base station apparatus 10b connected via the network a request that the old encryption key be outputted. Then the control unit 84 outputs the old encryption key to the second base station apparatus 10b in order that the old encryption key is used for tentative communication between the second base station 10b and the terminal apparatus 12. The control unit 84 performs the similar processing to that performed on the first base station apparatus 10a, on the second base station apparatus 10b and thereby sets a new encryption key. The control unit 84 reports the new encryption key to the second base station apparatus 10b via the IF unit 80 and, at the same time, manages the new encryption key through the buffer 82. That is, after having outputted the old encryption key, the control unit 84 manages the new encryption key determined between the second base station apparatus 10b and the terminal apparatus 12 in a state that tentative communication is being performed between the second base station apparatus 10b and the terminal apparatus 12.

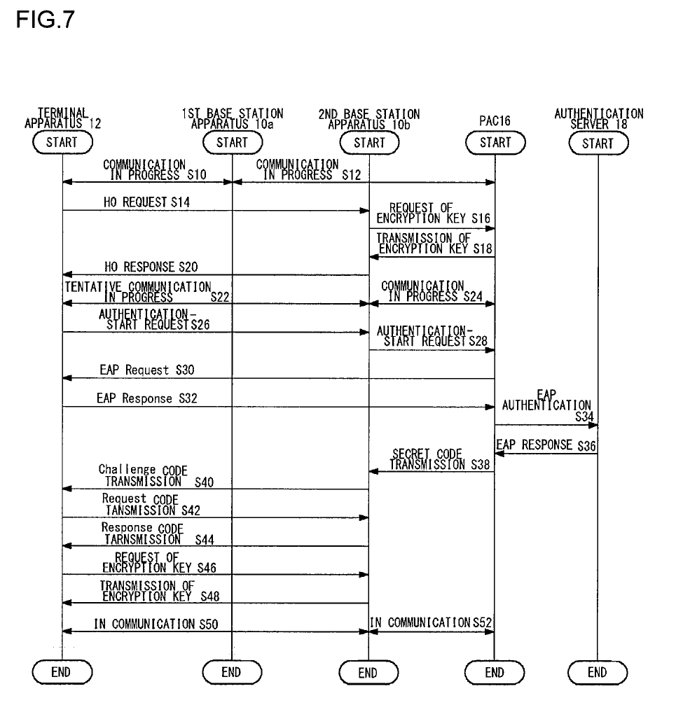

An operation of the communication system 100 configured as above will now be described. FIG. 7 is a sequence diagram showing a handover procedure in the communication system 100. The terminal apparatus 12 and the first base station apparatus 10a are communicating with each other (S10) and the first base station 10a and the PAC 16 are also communicating with each other (S12). The old encryption key is being used here. The terminal apparatus 12 transmits a handover (HO) request to the second base station apparatus 10b (S14). The second base station apparatus 10b requests the PAC 16 to transmit the encryption key (S16), and the PAC 16 transmits the encryption key to the second base station apparatus 10b (S18). The second base station apparatus 10b transmits an HO response to the terminal apparatus 12 (S20). As a result, the terminal apparatus 12 and second base station apparatus 10b starts performing tentative communication (S22) and the second base station apparatus 10b and the PAC 16 are communicating with each other (S24).

The terminal apparatus 12 transmits an authentication start request to the second base station apparatus 10b (S26), and the PAC 16 transmits the authentication start request to the PAC 16 (S28). The PAC 16 transmits an EAP request to the terminal apparatus 12 (S30). The terminal apparatus 12 transmits an EAP response to the PAC 16 (S32). The PAC 16 transmits an EAP authentication to the authentication server 18 (S34), and the authentication server 18 transmits the EAP response to the PAC 16 (S36). The PAC 16 transmits an encryption key to the second base station apparatus 10b (S38). The second base station apparatus 10b transmits a challenge code to the terminal apparatus 12 (S40), and the terminal apparatus 12 transmits a request code to the second base station apparatus 10b (S42).

The second base station apparatus 10b transmits a response code to the terminal apparatus 12 (S44). The terminal apparatus 12 requests the second base station apparatus 10b to transmit the encryption key (S46). The second base station apparatus 10b transmits the encryption key to the terminal apparatus (S48). As a result, the terminal apparatus 12 and the second base station apparatus lOb starts communicating with each other (S50) and the second base station apparatus 10b and the PAC 16 are communicating with each other (S52).

By employing the exemplary embodiment as described above, when a terminal apparatus is connected to a handover destination apparatus, tentative communication is performed therebetween using the old encryption key as it is, so that the period required till the start of the tentative communication can be shortened. Since the period required till the start of the tentative communication becomes shorter, high-speed handover can be executed. Since high-speed handover is executed, the user convenience can be improved. While the tentative communication is in progress, a new encryption key is set and the old encryption key is updated with the new encryption key, so that encrypted communication using the new encryption key can be performed. Since the encrypted communication is performed using the new encryption key, the level of compromising the security can be minimized. Also, the period required for the execution of handover can be shortened without compromising the security.

The present invention has been described based upon illustrative embodiments. These exemplary embodiments are intended to be illustrative only and it will be obvious to those skilled in the art that various modifications to constituting elements and processes could be developed and that such modifications are also within the scope of the present invention.

In the exemplary embodiment, the PAC 16 or the authentication server 18 generates the encryption keys. However, this should not be considered as limiting and, for example, the terminal apparatus 12 or the base station apparatus 10 may generate the encryption keys. In such a case, the first base station apparatus 10a may generate the old encryption key, and the second base station apparatus 10b may generate the new encryption key. Also, the PAC 16 may receive the encryption keys produced in the base station apparatus 10 and manage them. In this modification, the degree of freedom in configuring the communication system 100, namely the structural flexibility of the communication system 100, can be enhanced.

What is claimed is:

1. A base station apparatus, comprising:
a receiving unit which receives a handover request from a terminal apparatus;
a requesting unit which, upon receipt of the handover request in said receiving unit, requests a control apparatus connected via a network that an encryption key used for wireless communication performed between the terminal apparatus and a handover source base station apparatus be outputted;
a communication unit which, upon receipt of the encryption key from the control apparatus as a response to a request from said requesting unit, performs wireless communication with the terminal apparatus using the encryption key,
wherein while performing wireless communication with the terminal apparatus using the encryption key, said communication unit determines a new encryption key between said communication unit and the terminal apparatus, and continues to perform wireless communication after updating the encryption key with the new encryption key.

2. A base station apparatus according to claim 1, wherein said communication unit performs wireless communication with the terminal apparatus using the encryption key by setting a predetermined communication channel and determines the new encryption key between said communication unit and the terminal apparatus, by setting another communication channel.

3. A terminal apparatus, comprising:
a first communication unit which performs wireless communication with a handover source base station apparatus using an encryption key; and
a second communication unit which performs wireless communication with a handover destination base station apparatus tentatively using the encryption key used by the first communication unit,
wherein while performing wireless communication with the handover destination apparatus tentatively using the encryption key used by said first communication unit, said second communication unit determines a new encryption key between said second communication unit and the handover destination base station apparatus and continues to perform wireless communication after updating the encryption key with the new encryption key.

4. A control apparatus connected to a handover source base station apparatus performing wireless communication with a terminal apparatus via a network, the control apparatus comprising:
a management unit which manages an encryption key used for wireless communication between the handover source base station apparatus and the terminal apparatus; and
an instruction unit which, upon receipt of an output request of outputting the encryption key managed by said management unit from a handover destination base station apparatus connected to the network, outputs the encryption key managed by said management unit to the handover destination base station apparatus in order that the encryption key is tentatively used for wireless communication between the handover destination base station apparatus and the terminal apparatus,
wherein when a new encryption key is determined between the handover destination base station apparatus and the terminal apparatus after the encryption key has been outputted from said instruction unit in a state where the encryption key is being tentatively used between the handover destination base station apparatus and the terminal apparatus, said management unit manages the new encryption key.

5. A communication method, comprising:
performing wireless communication between a terminal apparatus and a handover source base station apparatus using an encryption key;
performing wireless communication between the terminal apparatus and a handover destination base station apparatus by tentatively using the encryption key;
determining a new encryption key by the terminal apparatus and the handover destination apparatus in a state where the encryption is being used tentatively; and
continuing to perform wireless communication between the terminal apparatus and the handover destination base station apparatus after the encryption key has been updated with the new encryption key.

6. A communication method, comprising:
managing an encryption key used for wireless communication between a handover source base station apparatus and a terminal apparatus; and
upon receipt of an output request of outputting the encryption key managed by said managing from a handover destination base station apparatus connected to a network, outputting the encryption key managed by said managing to the handover destination base station apparatus in order that the encryption key is tentatively used for wireless communication between the handover destination base station apparatus and the terminal apparatus; and
managing a new encryption key after said outputting the encryption key in a state where the encryption key is being used tentatively for wireless communication performed between the handover destination base station apparatus and the terminal, when the new encryption key is determined between the handover destination apparatus and the terminal.
